(19) United States
(12) Patent Application Publication
(10) Pub. No.: US 2019/0003144 A1
(43) Pub. Date: Jan. 3, 2019

(54) Corner Connection Structure of Steel Structure Comprehensive Pipe Gallery

(71) Applicant: NANJING LIANZHONG CONSTRUCTION ENGINEERING TECHNOLOGY CO., LTD, Nanjing (CN)

(72) Inventor: Fujun ZHAN, Nanjing (CN)

(21) Appl. No.: 16/125,495

(22) Filed: Sep. 7, 2018

(51) Int. Cl. E02D 29/00; F16B 5/08; F16B 5/00

(52) U.S. Cl. CPC E02D 29/10; F16B 5/08; E02D 2600/20; E02D 2300/0032; E02D 2200/12; F16B 5/0004

(57) ABSTRACT

A corner connection structure of a steel structure comprehensive pipe gallery, where corrugated steel plates respectively located on an upper face, a lower face and two side faces are spliced in a circumferential direction to form pipe joints; when the corrugated steel plates are spliced in the circumferential direction, contact end portions of adjacent corrugated steel plates are provided with a pair of groove-shaped flanges capable of wrapping inner and outer walls of respective corrugated steel plate, contact faces of the pair of groove-shaped flanges are fixedly connected to each other, outer folded edges of the groove-shaped flanges and the outer walls of the corrugated steel plates are separated by gaps, inner folded edges of the groove-shaped flanges and the inner walls of the corrugated steel plates are separated by gaps, and inner reinforcing blocks and/or outer reinforcing blocks are respectively arranged in the gaps.

### TECHNICAL FIELD

The utility model discloses a corner connection structure of a pipe gallery, and more particularly relates to a corner connection structure of a steel structure comprehensive pipe gallery.

### BACKGROUND ART

The applicant has applied for patents for many steel structure pipe galleries, such as a rectangular-like arched pipe gallery, the arched pipe gallery has four panels, four corners are formed, if flat and straight flanges are used as circumferential connection flanges of the four corners of the arched pipe gallery, cross sectional moment of inertia of the flat and straight flanges is too small, and after the pipe gallery is filled with soil, welded sharp portions of corrugated steel plates and the flat and straight flanges bear tensile force, which causes pulling disengagement easily. If L-shaped or groove-shaped structural steel is used as longitudinal flanges, in actual machining, attached sharp corner positions of folded edges of the flanges and the corrugated steel plates cannot be welded, weld joint quality cannot be guaranteed, and a sealing effect of an overall structure is difficult to guarantee. More importantly, a stress direction of a weld bead of the corrugated steel plates and the circumferential connection flanges during work is consistent with a thickness direction of the corrugated steel plate, which violates a weld bead stress convention, a stress state of the weld bead is poor, pulling breakage is caused easily, and consequently connection strength of the corrugated steel plates and the circumferential connection flanges is small. In addition, if folded edges, outside a gallery body, of the circumferential connection flanges are too wide, arranging and installing of longitudinal flange bolts between every two adjacent corrugated steel plates will be affected.

Thus, the above-mentioned technical problems urgently need to be solved.

### SUMMARY OF THE UTILITY MODEL

Patent purposes: the utility model aims to provide a corner connection structure of a steel structure comprehensive pipe gallery, which ensures that strength of a whole box-shaped structure is not affected under a condition that a weld joint cracks under frequent effects of a static load and a dynamic load.

Technical scheme: according to the corner connection structure of the steel structure comprehensive pipe gallery of the utility model, corrugated steel plates respectively located on an upper face, a lower face and two side faces are spliced in a circumferential direction to form pipe joints, when the corrugated steel plates are spliced in the circumferential direction, contact end portions of adjacent corrugated steel plates are provided with a pair of groove-shaped flanges capable of wrapping inner and outer walls of respective corrugated steel plate, contact faces of the pair of groove-shaped flanges are fixedly connected to each other, outer folded edges of the groove-shaped flanges and the outer walls of the corrugated steel plates are separated by gaps, inner folded edges of the groove-shaped flanges and the inner walls of the corrugated steel plates are separated by gaps, and inner reinforcing blocks and/or outer reinforcing blocks are respectively arranged in the gaps, and integrally welded with the corrugated steel plates and the groove-shaped flanges. The corner connection structure of the comprehensive pipe gallery solves the problems that in the splicing process, attached sharp corner positions of splicing flanges, namely the groove-shaped flanges, and the corrugated steel plates cannot be welded, and bolts are difficult to arrange. The additionally arranged inner and outer reinforcing blocks enhance connection strength between the corrugated steel plates and the groove-shaped flanges, solidify weld joint strength at spliced sharp corner positions, and meanwhile increase inner and outer folded edge strength of the groove-shaped flanges, so that when the inner folded edges are utilized as a force applying point of a pipe gallery support, bearing capacity of the support is well improved.

Where, the inner folded edges of the groove-shaped flanges on the corrugated steel plates located on the upper face and the lower face are in a horizontal state.

Furthermore, the inner folded edges of the groove-shaped flanges on the corrugated steel plates located on the two side faces are in a vertical state.

Furthermore, the inner folded edge of the groove-shaped flange is provided with a connection hole used for arranging the support. In the corner connection structure, the inner folded edges of the groove-shaped flanges in the horizontal state or the vertical direction achieve installing and using of the support in the pipe gallery through the connection hole.

Preferably, the inner reinforcing block or the outer reinforcing block is one reinforcing block, or is a plurality of reinforcing blocks arranged in parallel or non-parallel in a spaced manner. According to different actual strength requirements of the corner connection structure, a number and an arranging manner of the inner and outer reinforcing blocks can be freely set.

Furthermore, a cross section of the outer reinforcing block is in a flat and straight shape or a U shape.

Where, one end of the outer reinforcing block with a U-shaped cross section extends and is bent outwards to form a hook-like end, and the hook-like end wraps an outer wall, at a corner bent position, of the groove-shaped flange. The outer reinforcing block additionally arranged in the corner connection structure can further enhance longitudinal and transverse rigidity of the groove-shaped flange, meanwhile, connection strength of the corrugated steel plate and the groove-shaped flange is enhanced, the hook-like end of the outer reinforcing block and the corner bent position of the groove-shaped flange are attached and connected, which can further enhance corner strength of the groove-shaped flange, and stress concentration is prevented.

Preferably, at least one pulling rod is arranged between a wave peak, provided with the outer reinforcing block, of the corrugated steel plate and the outer folded edge of the groove-shaped flange.

Another corner connection structure of a steel structure comprehensive pipe gallery is provided, wherein corrugated steel plates respectively located on an upper face, a lower face and two side faces are spliced in a circumferential direction to form pipe joints; when the corrugated steel plates are spliced in the circumferential direction, contact end portions of adjacent corrugated steel plates are provided with a pair of groove-shaped flanges capable of wrapping end portions of inner and outer walls of the corrugated steel plates, bottom faces of the pair of groove-shaped flanges are fixedly connected to each other, and inner and outer folded edges of the groove-shaped flanges are connected with the corrugates steel plates; and at least one pulling rod is arranged between a wave peak of an inner wall and/or an outer wall of the corrugated steel plate and the inner and outer folded edges of the groove-shaped flange.

Preferably, the pulling rod is an A-shaped pulling rod, a peak portion of the A-shaped pulling rod is connected with the outer wall of the corrugated steel plate, the other two ends are connected with the groove-shaped flanges, and a triangular space is defined. The A-shaped pulling rods are additionally arranged on the inner and outer walls of the corrugated steel plates of the comprehensive pipe gallery, the A-shaped pulling rods, the corrugates steel plates and the groove-shaped flanges are mutually connected in a bolt manner, it is guaranteed that strength of a whole structure is not affected even under a severe condition that a weld joint cracks and like under frequent effects of a static load and a dynamic load, shearing force borne by the weld joint is further reduced, safety of the pipe gallery is effectively guaranteed, and strength and stability of the whole pipe gallery are further enhanced.

Beneficial effects: compared with the prior art, the utility model has the following advantages:
(1) The corner connection structure of the comprehensive pipe gallery solves the problems that in the splicing process, the attached sharp corner positions of the splicing flanges, namely the groove-shaped flanges, and the corrugated steel plates cannot be welded, and the bolts are difficult to arrange.
(2) The additionally arranged inner and outer reinforcing blocks further enhance the connection strength between the corrugated steel plates and the groove-shaped flanges, enhance the weld joint strength at the spliced sharp corner positions, and meanwhile increase inner and outer folded edge strength of the groove-shaped flanges, so that when the inner folded edges are utilized as the force applying point of the pipe gallery support, the bearing capacity of the support is well improved.
(3) In the corner connection structure, the inner folded edges of the groove-shaped flanges in the horizontal state or the vertical state facilitate installing and using of the support in the pipe gallery.
(4) In the corner connection structure, the hook-like end of the additionally arranged outer reinforcing block and the corner bent position of the groove-shaped flange are attached and connected, which can further enhance the corner strength of the flange, and stress concentration is prevented.

The A-shaped pulling rods are additionally arranged on the outer walls of the corrugated steel plates of the comprehensive pipe gallery, the A-shaped pulling rods, the corrugates steel plates and the groove-shaped flanges are mutually connected in a bolt manner, it is guaranteed that the strength of the whole structure is not affected even under the severe condition that the weld joint cracks and like under the frequent effects of the static load and the dynamic load, the shearing force borne by the weld joint is further reduced, the safety of the pipe gallery is effectively guaranteed, and the strength and the stability of the whole pipe gallery are further enhanced.

### BRIEF DESCRIPTION OF THE DRAWINGS

FIG. 1 is a structural schematic diagram of a comprehensive pipe gallery with groove-shaped flanges in the utility model;

FIG. 2 is an end face schematic diagram of the comprehensive pipe gallery with the groove-shaped flanges in the utility model;

FIG. 3 is a partial sectional view of an end portion of a corrugated steel plate in the utility model;

FIG. 4 is a partial schematic view of a corner connection structure with A-shaped pulling rods in the utility model;

FIG. 5 is a local sectional view of FIG. 4;

FIG. 6 is a local sectional view of a U-shaped outer reinforcing block;

FIG. 7 is a structural schematic diagram of a flat and straight outer reinforcing block;

FIG. 8 is a structural schematic diagram of the U-shaped outer reinforcing block; and

FIG. 9 is a structural schematic diagram of a U-shaped outer reinforcing block with a hook-like end.

### DETAILED DESCRIPTION OF THE UTILITY MODEL

The technical scheme of the utility model is further illustrated in combination with the drawings.

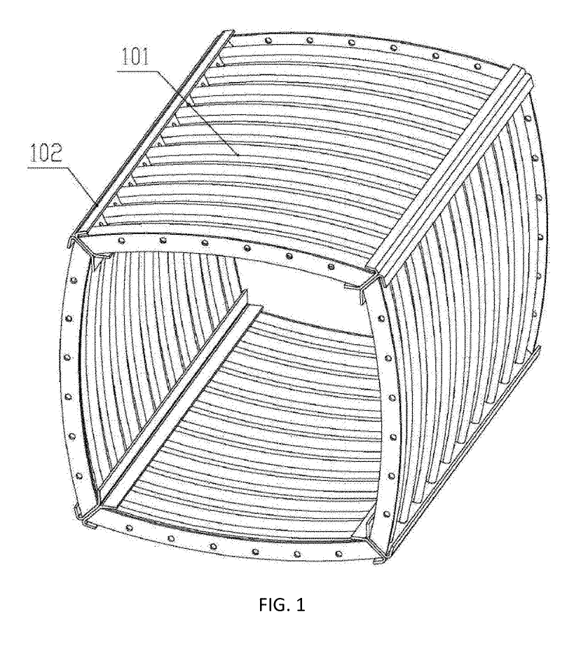

As shown in FIG. 1, according to a corner connection structure of a steel structure comprehensive pipe gallery of the utility model, corrugated steel plates 101 respectively located on an upper face, a lower face and two side faces are spliced in a circumferential direction to form pipe joints; and when the corrugated steel plates 101 are spliced in the circumferential direction, contact end portions of adjacent corrugated steel plates 101 are provided with a pair of groove-shaped flanges 102 capable of wrapping inner and outer walls of respective corrugated steel plate. The groove-shaped flange 102 is formed by bending a metal plate, or is formed by combining and assembling a pair of bent plates bent to a certain angle. The adjacent corrugated steel plates with the groove-shaped flanges 102 achieve fast connection through bolts, installing is convenient and fast, and construction progress is greatly improved. Contact faces of the pair of groove-shaped flanges 102 are fixedly connected to each other, outer folded edges of the groove-shaped flanges and the outer walls of the corrugated steel plates 101 are separated by gaps, inner folded edges of the groove-shaped flanges and the inner walls of the corrugated steel plates 101 are separated by gaps, filling welding is performed on the gaps, after filling of weld joints at attached sharp corner positions of the groove-shaped flanges and the corrugated steel plates is completed, the groove-shaped flanges and two folded edges can be welded to the corrugated steel plates or connected with the corrugated steel plates through the bolts. The corner connection structure of the comprehensive pipe gallery solves the problems that in the splicing process, attached sharp corner positions of splicing flanges, namely the groove-shaped flanges, and the corrugated steel plates cannot be welded, and the bolts are difficult to arrange.

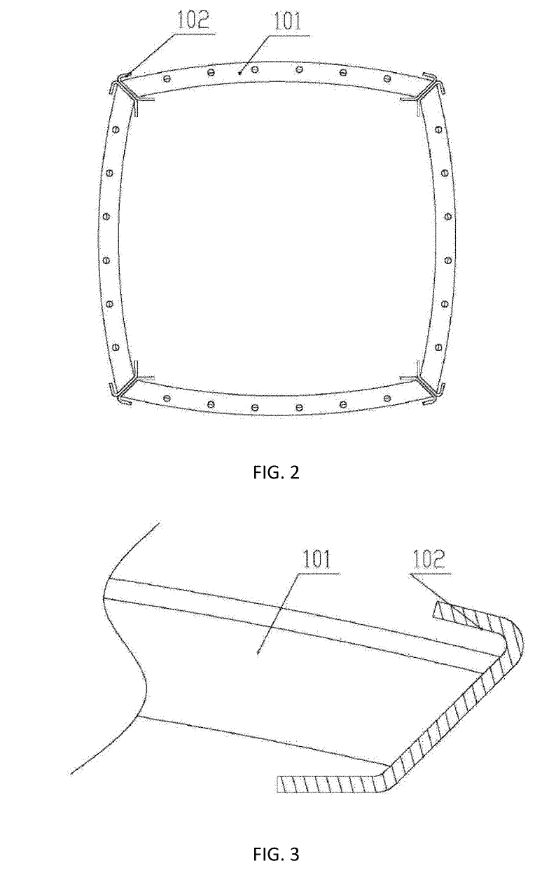

As shown in FIG. 2, the inner folded edges of the groove-shaped flanges on the corrugated steel plates 101 located on the upper face and the lower face are in a horizontal state, and the inner folded edges of the groove-shaped flanges on the corrugated steel plates 101 located on the two side faces are in a vertical state. The inner folded edges of the groove-shaped flanges in the horizontal state or the vertical state facilitate installing and using of a support in the pipe gallery.

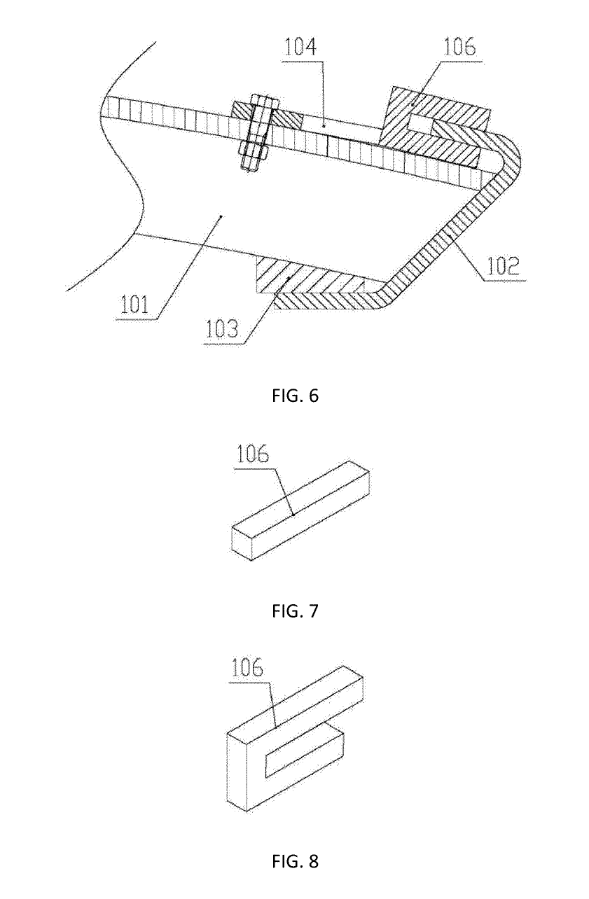

As shown in FIG. 5 and FIG. 6, bottom faces of the pair of groove-shaped flanges make contact with each other, and are fixedly connected through bolts or are welded and fixed, the outer folded edges of the groove-shaped flanges and the corrugated steel plates 101 are separated by gaps, and the inner folded edges of the groove-shaped flanges and the inner walls of the corrugated steel plates 101 are separated by gaps. Inner reinforcing blocks 103 are arranged in gaps between wave peaks and/or wave troughs of the inner walls of the corrugated steel plates 101 and the inner folded edges of the groove-shaped flanges, the inner reinforcing blocks 103, the corrugated steel plates 101 and the inner folded edges of the groove-shaped flanges 102 are fixedly connected into a whole, and welding is adopted as a specific fixed connection manner. The additionally arranged inner reinforcing blocks further enhance connection strength between the corrugated steel plates and the groove-shaped flanges, enhance weld joint strength at spliced sharp corner positions, and meanwhile increase inner folded edge strength of the groove-shaped flanges, so that when the inner folded edges are utilized as a force applying point of the pipe gallery support, bearing capacity of the support is well improved.

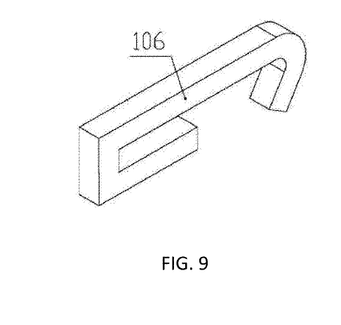

As shown in FIG. 5 and FIG. 6, outer reinforcing blocks 106 are arranged in the gaps between wave peaks/wave troughs of the outer walls of the corrugated steel plates 101 and the outer folded edges, the outer reinforcing blocks 106, the corrugated steel plates 101 and the outer folded edges of the groove-shaped flanges 102 are fixedly connected into a whole, and welding is adopted as a specific fixed connection manner. As shown in FIG. 7 and FIG. 8, a cross section of the outer reinforcing block 106 is in a flat and straight shape or a U shape. As shown in FIG. 9, one end of the outer reinforcing block 106 with a U-shaped cross section extends and is bent outwards to form a hook-like end, and the hook-like end wraps an outer wall, at a corner bent position, of the groove-shaped flange. The outer reinforcing block additionally arranged in the corner connection structure can further enhance longitudinal and transverse rigidity of the groove-shaped flange, meanwhile, connection strength of the corrugated steel plate and the groove-shaped flange is enhanced, the hook-like end of the outer reinforcing block and the corner bent position of the groove-shaped flange are attached and connected, which can further enhance corner strength of the groove-shaped flange, and stress concentration is prevented.

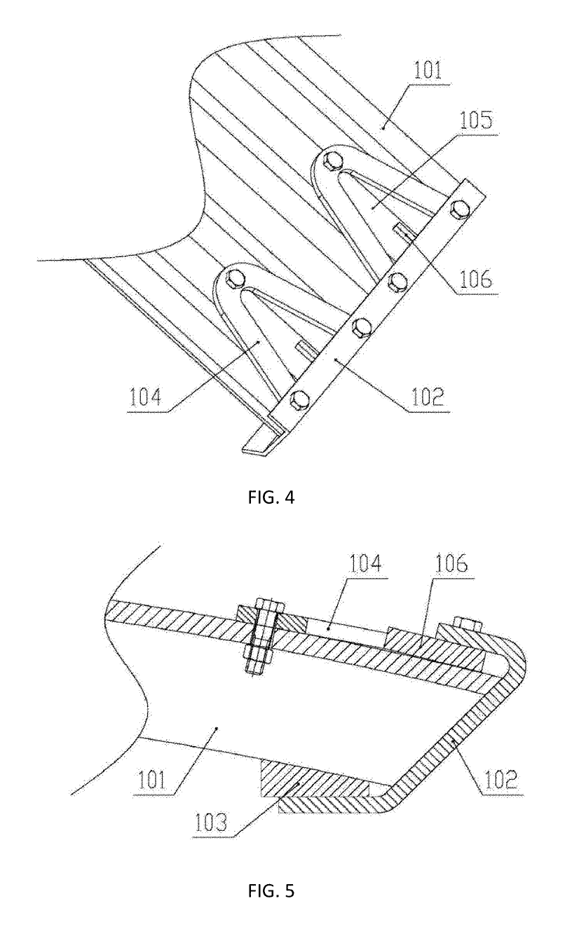

As shown in FIG. 4, at least one pulling rod 104 is arranged between the wave peak, provided with the outer reinforcing block 106, of the corrugated steel plate 101 and the outer folded edge of the groove-shaped flange 102.

According to another corner connection structure of a steel structure comprehensive pipe gallery, wherein corrugated steel plates 101 respectively located on an upper face, a lower face and two side faces are spliced in a circumferential direction to form pipe joints; when the corrugated steel plates 101 are spliced in the circumferential direction, contact end portions of adjacent corrugated steel plates 101 are provided with a pair of groove-shaped flanges 102 capable of wrapping end portions of inner and outer walls of the corrugated steel plates, bottom faces of the pair of groove-shaped flanges 102 are fixedly connected to each other, and inner and outer folded edges of the groove-shaped flanges are connected with the corrugates steel plates 101; and at least one pulling rod 104 is arranged between a wave peak of an inner wall and/or an outer wall of the corrugated steel plate 101 and the inner and outer folded edges of the groove-shaped flange 102. No inner and outer reinforcing blocks are arranged in the comprehensive pipe gallery, only the A-shaped pulling rods are additionally arranged, the A-shaped pulling rods, the corrugates steel plates and the groove-shaped flanges are mutually connected in a bolt manner, it is guaranteed that strength of a whole structure is not affected even under a severe condition that a weld joint cracks and the like under frequent effects of a static load and a dynamic load, shearing force borne by the weld joint is further reduced, safety of the pipe gallery is effectively guaranteed, and strength and stability of the whole pipe gallery are further enhanced.

The pulling rod 104 is the A-shaped pulling rod, a peak portion of the A-shaped pulling rod and the outer wall of the corrugated steel plate are connected in a bolt manner, and preferably, the peak portion of the A-shaped pulling rod is connected with a wave peak of a corrugated plate sheet; and the other two ends are connected with the groove-shaped flanges 102, and a triangular space 105 is defined. The A-shaped pulling rod can be formed by bending a flat steel plate, or is formed by combing two strip-shaped steel plates. Furthermore, an outer reinforcing block can be arranged in the triangular space 105. The A-shaped pulling rods are additionally arranged on the outer walls of the corrugated steel plates of the comprehensive pipe gallery, and the A-shaped pulling rods, the corrugated steel plates and the groove-shaped flanges are mutually connected through bolts, it is guaranteed that the strength of the whole structure is not affected even under the severe condition that the weld joint cracks and the like under the frequent effects of the static load and the dynamic load, the shearing force borne by the weld joint is further reduced, the safety of the pipe gallery is effectively guaranteed, and the strength and the stability of the whole pipe gallery are further enhanced.

The corner connection structure is adopted by the utility model to achieve corner splicing and connecting, overall construction progress is greatly accelerated, a stress condition of a corner stress concentration area is greatly improved, and the phenomena that because of a singular welding connection manner of the corner connection structure and the corrugated steel plates, under a dynamic load work condition, the weld joint cracks, and a pipe body structure is damaged and like are avoided. End portions of the corrugated steel plates are wrapped by the corner connection structure, the corrugated steel plates and the groove-shaped flanges are connected in a bolt connection manner, the shearing force borne by the weld joint is further reduced, and weld joint protection is better facilitated.

What is claimed is:

1. A corner connection structure of a steel structure comprehensive pipe gallery, wherein corrugated steel plates (101) respectively located on an upper face, a lower face and two side faces are spliced in a circumferential direction to form pipe joints; when the corrugated steel plates (101) are spliced in the circumferential direction, contact end portions of adjacent corrugated steel plates (101) are provided with a pair of groove-shaped flanges (102) capable of wrapping inner and outer walls of respective corrugated steel plate, contact faces of the pair of groove-shaped flanges (102) are fixedly connected to each other, outer folded edges of the groove-shaped flanges and the outer walls of the corrugated steel plates (101) are separated by gaps, inner folded edges of the groove-shaped flanges and the inner walls of the corrugated steel plates (101) are separated by gaps, and inner reinforcing blocks (103) and/or outer reinforcing blocks (106) are respectively arranged in the gaps, and integrally welded to the corrugated steel plates (101) and the groove-shaped flanges (102).

2. The corner connection structure of the steel structure comprehensive pipe gallery according to claim 1, wherein the inner folded edges of the groove-shaped flanges (102) on the corrugated steel plates (101) located on the upper face and the lower face of the pipe gallery are in a horizontal state.

3. The corner connection structure of the steel structure comprehensive pipe gallery according to claim 1, wherein the inner folded edges of the groove-shaped flanges (102) on the corrugated steel plates (101) located on the two side faces of the pipe gallery are in a vertical state.

4. The corner connection structure of the steel structure comprehensive pipe gallery according to claim 2, wherein the inner folded edge of the groove-shaped flange (102) is provided with a connection hole used for arranging a support.

5. The corner connection structure of the steel structure comprehensive pipe gallery according to claim 1, wherein the inner reinforcing block (103) or the outer reinforcing block (106) is one reinforcing block, or is a plurality of reinforcing blocks arranged in parallel or non-parallel in a spaced manner.

6. The corner connection structure of the steel structure comprehensive pipe gallery according to claim 1, wherein a cross section of the outer reinforcing block (106) is in a flat and straight shape or a U shape.

7. The corner connection structure of the steel structure comprehensive pipe gallery according to claim 6, wherein one end of the outer reinforcing block (106) with a U-shaped cross section extends and is bent outwards to form a hook-like end, and the hook-like end wraps an outer wall, at a corner bent position, of the groove-shaped flange.

8. The corner connection structure of the steel structure comprehensive pipe gallery according to claim 1, wherein at least one pulling rod (104) is arranged between a wave peak, provided with the outer reinforcing block (106), of the corrugated steel plate (101) and the outer folded edge of the groove-shaped flange (102).

9. A corner connection structure of a steel structure comprehensive pipe gallery, wherein corrugated steel plates (101) respectively located on an upper face, a lower face and two side faces are spliced in a circumferential direction to form pipe joints; when the corrugated steel plates (101) are spliced in the circumferential direction, contact end portions of adjacent corrugated steel plates (101) are provided with a pair of groove-shaped flanges (102) capable of wrapping end portions of inner and outer walls of the corrugated steel plates, bottom faces of the pair of groove-shaped flanges (102) are fixedly connected to each other, and inner and outer folded edges of the groove-shaped flanges are connected with the corrugates steel plates (101); and at least one pulling rod (104) is arranged between a wave peak of an inner wall and/or an outer wall of the corrugated steel plate (101) and the inner and outer folded edges of the groove-shaped flange (102).

10. The corner connection structure of the steel structure comprehensive pipe gallery according to claim 9, wherein the pulling rod (104) is an A-shaped pulling rod, a peak portion of the A-shaped pulling rod is connected with the outer wall of the corrugated steel plate, the other two ends are connected with the groove-shaped flanges (102), and a triangular space (105) is defined.
